(19) United States
(12) Patent Application Publication
(10) Pub. No.: US 2009/0292950 A1
(43) Pub. Date: Nov. 26, 2009

(54) METHOD FOR MAKING TEST FIXTURE

(75) Inventor: Cheng-Feng Tsai, Taipei (TW)

Correspondence Address: J C PATENTS, 4 VENTURE, SUITE 250, IRVINE, CA, 92618, US

(73) Assignee: INVENTEC CORPORATION, Taipei City (TW)

(21) Appl. No.: 12/168,304

(22) Filed: Jul. 7, 2008

(30) Foreign Application Priority Data
May 20, 2008 (TW) 97118545

(51) Int. Cl. G06F 11/26

(52) U.S. Cl. 714/36; 714/E11.159

(57) ABSTRACT

A method for making a test fixture includes the following steps. A Linux operating system is installed to a computer storage device and a test program is installed to the storage device. Which kernels have been installed in the Linux operating system is checked to obtain a check result. A part of or entire content of the storage device is copied to a system image file except a boot file. A boot file directory structure is made in the system image file. The boot file in the storage device is customized to make a disc boot file in the boot file directory structure. The check result is recorded in the disc boot file. An initrd file corresponding to the check result is created in the boot file directory structure according to the boot file in the storage device. A bootable test disc is made using the system image file.

### CROSS-REFERENCE TO RELATED APPLICATION

This application claims the priority benefit of Taiwan application serial no. 97118545, filed on May 20, 2008. The entirety of the above-mentioned patent application is hereby incorporated by reference herein and made a part of this specification.

### BACKGROUND OF THE INVENTION

1. Field of the Invention

The present invention generally relates to test of computer products, and particularly, to a method for making a test fixture for testing computer products.

2. Description of Related Art

Technology development has resulted in increasingly frequent use of computers, for example, in families or factories for various aspects of application. At the same time, however, some computer-related problems may arise from the frequent use of the computers. Therefore, functional test can be a very important step during manufacture or repair of the computer products. As for the test for computers, the test for computer function can be performed under different operation systems (e.g., Linux). However, system software (e.g., RedHat) must be installed prior to the test. After the system software is installed, a test program is then installed, and subsequently, the test for various hardware functions can begin. If a storage card is replaced or the system software for testing computers is accidentally damaged, the system software and test program must be re-installed before the test can be performed again. However, re-installing of the system software and test program can be time-consuming.

In general, prior to shipment, a functional test is performed to the computer products in the same way as described above. Therefore, the system software must be first installed before the functional test can be performed. As a result, it has been often impossible to test a large quantity of computer products to determine whether the computer products meet the shipment standard in a short time.

### SUMMARY OF THE INVENTION

Accordingly, the present invention is directed to a method for making a test fixture (e.g., a test CD) that can be used to reduce the time for testing computer products.

The present invention provides a method for making a test fixture, which is suitable for making a test optical disc to be used a test fixture for testing a computer product. The method includes the following steps. Firstly, an Open Source operating system is installed to a storage device of a computer, and at least one test program for the testing is installed to the storage device. It is checked which kernels have been installed in the Open Source operating system to obtain a check result. A part of or entire content of the storage device is copied to a system image file except a boot file. A boot file directory structure is made in the system image file. The boot file of the virtual platform system in the storage device is customized to make a disc boot file in the boot file directory structure. The check result is recorded in the disc boot file. An initial Ram disk file corresponding to the check result is created in the boot file directory structure according to the boot file in the storage device. A bootable test disc is made using the system image file.

The method of the present invention is suitable for making a test CD with multi-systems to be used as a test fixture to test computer products. Installation of an operating system is not required to use the test fixture, such that the computer product can perform a rapid test. Thus, this method reduces the time for testing the computer product, thereby increasing the shipment speed and quality of the computer products.

In order to make the aforementioned and other features and advantages of the present invention more comprehensible, embodiments accompanied with figures are described in detail below.

### BRIEF DESCRIPTION OF THE DRAWINGS

FIG. 1 illustrates a flow chart of a method for making a test fixture according to one embodiment of the present invention.

FIG. 2 illustrates a flow chart of a method for creating a disc boot file according to one embodiment of the present invention.

FIG. 3 illustrates a flow chart of a method for making an initrd file according to one embodiment of the present invention.

### DESCRIPTION OF THE EMBODIMENTS

Existing Live CD making tools usually can only install a standard new operating system to an optical disc or CD image file and cannot install a customized operating system to an optical disc image file. In attempts to address this problem, the present invention proposes to completely move a customized Open Source operating system (e.g. Linux) in a machine to an optical disc image file to make a test fixture, such that the test fixture and the customized operating system in the machine share same services and settings. As the test fixture operates, it provides a virtual operating environment as if the customized operating system were running. Thereby, the present invention provides a method that can rapidly test computer products.

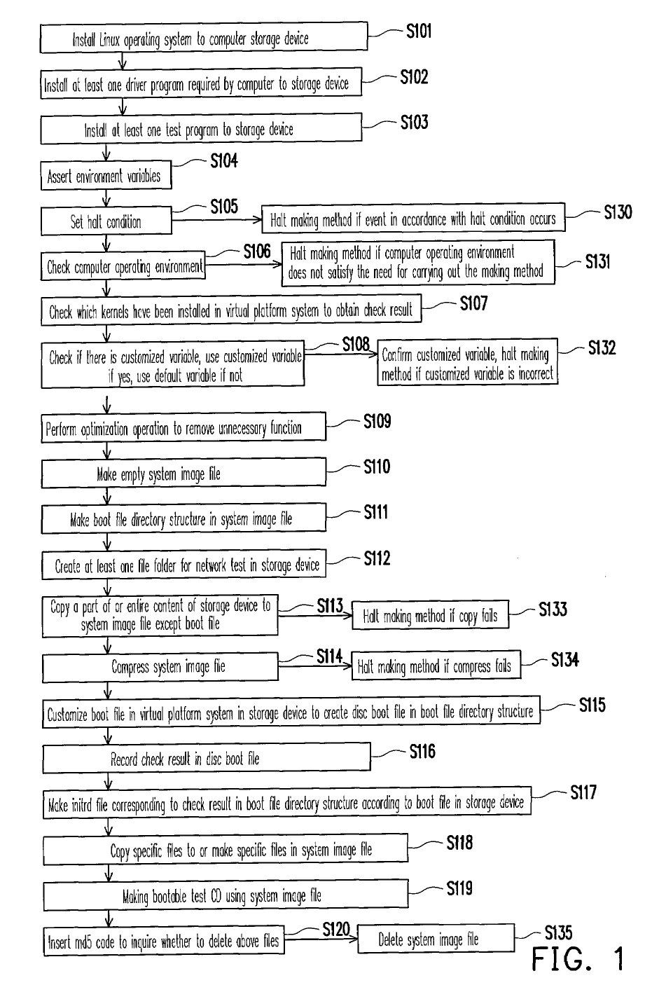

FIG. 1 illustrates a method for making a test fixture according to one embodiment of the present invention. Referring to FIG. 1, firstly, a Linux operating system is installed to a storage device of a computer (Step S101). In this exemplary embodiment, the Linux operating system is RHEL system software, and the storage device is a hard disk, for example. After the Linux operating system has been installed, virtual software Xen and its kits are installed. This virtual software allows kernels (e.g., Fredora, Mandrake, SUSE, Knoppix) of multiple other system software to be installed in the storage device of the same computer and collects the installed kernels into a /boot directory. In step S102, at least one driver program required by the computer is installed to the storage device according to the kernels of the Linux operating system. The driver program can vary with the computer hardware and user's need. Afterwards, in step S103, at least one test program is installed in the storage device according to the user's preference or function to be tested.

In the embodiment above, the test fixture is illustrated as a test CD for the purpose of description only and should not be considered to be limiting. A customized system is achieved after the foregoing steps are performed. Making the test fixture is then discussed below. In this embodiment, the steps S104˜S135 are implemented by programs (e.g. RHEL_livecd.sh). After the step S103 is performed, the RHEL_livecd.sh program can be run to make the test CD. The RHEL_livecd.sh program contains a plurality of subprograms to be run during making the test disc as discussed in detail below. In step S104, environment variable assertion is performed to assert global variables and their default values (e.g., KER, CMELINE) for the program. In step S105, a halt condition is then set. This function is provided by a subprogram getTRAP of the RHEL_livecd.sh and allows the user to halt the making of the test fixture during the making process. In various embodiments of the present invention, the halt condition may be a depressing of CTRL+C or CTRL+Z by a user.

Afterwards, in step S106, each of subprograms CHKRPM, CHKKNLRPM and OPTCHK checks the operating environment of the computer. Specifically, the subprogram CHKRPM checks whether RedHat package manager (RPM) kits have been installed, the subprogram CHKKNLRPM checks whether corresponding kernel-devel kits have been installed, and the subprogram OPTCHK detects whether options has been inputted. The operating environment requires that the specific program be run by root identity, the size of the entire operating system be less then 4.3 Gbyte, and all necessary kits be installed (including anaconda*, kernel-devel, syslinux). At the same time, the subprogram CHKKNLRPM checks all installed kernels of the Linux operating system that are recorded in /boot directory (step S107), and records the check result in the variable KER.

After the operating environment check is completed, it is checked whether customized variables are present in step S108. If there are customized variables, then the customized variables are used. If not, default variables are used. In various embodiments of the present invention, the customized variables include, for example, a user defined temporary file path, a saving path, and the like. The subprogram FITLIVE then performs optimization operation to remove unnecessary function from the operating system in step S109. In one embodiment, the subprogram FITLIVE adds user defined optimization rules into the operating system boot programs. Here, the user must edit the content of the rhel-live file in advance to define services to be enabled. In the rhel-live file, the user may define that a cat /proc/cmdline command is used to acquire the boot option if an ordinary kernel is used to boot, and if the Xen kernel is used to boot, the boot option is acquired not using the cat /proc/cmdline command but instead using an echo $CMDLINE command. The ordinary kernel referred herein means a kernel of a non-virtual platform system.

After the customized system environment is created, an empty image file is then created by a subprogram MKEXT3IMG (step S110). After the empty image file is created, the subprogram MKEXT3IMG formats the system image file to create a third extended filesystem (EXT3), tunes the filesystem and mounts the image file for use. After the image file is mounted, an empty boot file directory system is created in the system image file (step S111). The created directories include dev, media, misc, mnt, proc, srv, sys, tmp, and, at the same time, a mount empty file folder is created for network test (step S112). A part of or entire contents on the hard disk, except the boot file, is then copied to the system image file (step S113). The copied directories include bin, boot, etc, home, lib, lib64, net, opt, root, sbin, selinux, tftpboot, usr and var. Settings of /etc/samba/smb.conf, etc/mtab, etc/fstab are then tuned to meet the operating requirement of the test CD.

After the copy of the customized system is completed, the system image file is compressed in step S114 using a subprogram MKSQUASH. This compress is performed to compress the EXT3 into a Squashfs file system format. The compress command is as follows:

mksquashfs<source file><destination file name>

After the compress is completed, the boot file of the operating system in the hard disk is customized to create a disc boot file in the boot file directory system in step S115. In step S116, the content of the variable KER that records the check result is then recorded in the disc boot file. In step S117, an initial Ram disk (initrd) file corresponding to the check result is created in the boot file directory structure according to the boot file in the hard disk. In step S118, specific files are copied to or created in the system image file. In various embodiments of the present invention, the specific files include, for example, desktop image files, description files, or the like. Finally, in step S119, a bootable test CD is made by using the system image file, which is performed by a subprogram MKISO.

After the foregoing steps are performed, the test fixture is accomplished. In this illustrated embodiment, events occurring in some steps will halt the making of the test fixture. For example, in step S105, the halt condition is set as a depressing of CTRL+C or CTRL+Z by a user. Whenever an event in accordance with the halt condition occurs (step S130), i.e., a depressing of CTRL+C or CTRL+Z by a user occurs, the making method is halted. Then, in step S106, the operating environment of the computer is checked. If the operating environment of the computer does not satisfy the need for performing the method of making the test fixture, the method is halted. In the illustrated embodiment, whether the operating environment is satisfactory depends upon whether the requirements described in step S106 are met.

Next, in step S108, it is checked whether a customized variable is present. If the customized variable is used, the method proceeds to step S132 where the customized variable is confirmed. If the result of the confirm shows that the customized variable is incorrect, then the method is halted. In step S113, when a part of the contents in the storage device is copied to the system image file, if the copy fails, the method is halted (step S133). The failure may possibly be caused by a system source error, system shut-down or interference with other programs. Likewise, in step S114, the system image file is compressed. If the compress fails, the method is halted (step S134). The failure may also possibly be caused by a system source error, system shut-down or interference with other programs.

In addition, after the test fixture is made, step S120 is performed which inserts an md5 test code and inquires whether to delete the system image file. This test code is provided to enable the system to detect whether the image file is made correctly. If the answer to this inquiry shows that the user does not want to reserve the temporary files for making the test disc, the system image file is deleted in step S135.

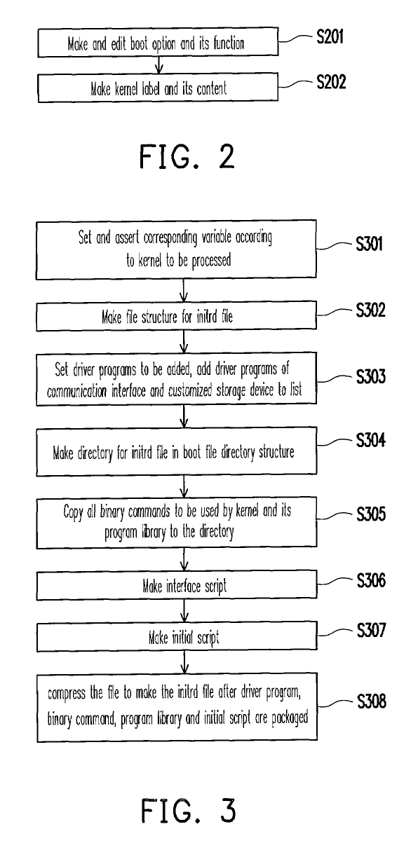

In order to make the present invention comprehensive to those skilled in the art, an exemplary embodiment is described below which shows a method for creating a disc boot file, a method for creating a virtual memory (vmlinuz) file, a method for creating an initrd file, and the content of the disc boot file. FIG. 2 is a flow chart of a method for creating a disc boot file according to one embodiment of the present invention. Referring to FIG. 2, a subprogram MKBootLoader is run to create and edit a boot option and its function (step S201), and then, a subprogram MKINITRAM is run to create a kernel label and its content (S202), thereby creating the disc boot file. In order to make the present invention more comprehensive, the operations of the subprograms MKBootLoader and MKINITRAM are discussed below.

The operation of the subprogram MKBootLoader is first described. Firstly, isolinux.bin in the hard disk is copied to the /isolinux directory of the system image file. If the isolinux.bin is not found in the hard disk, then the isolinux.bin in the RHEL_livecd.sh program library is copied. Then, vesamenu.c32 in the hard disk is copied to the /isolinux directory of the system image file. If the vesamenu.c32 is not found in the hard disk, the vesamenu.c32 in the RHEL_livecd.sh program library is copied. Next, a jpg file is copied to the /isolinux directory of the system image file. If the system software is Fedora and if the splashjpg is not found in the hard disk, a fedorajpg in the RHEL_livecd.sh program library is copied; if the system software is RHEL, the user is prompted to select a desired background image. If the desired background image is not found in the hard disk, bluejpg in the RHEL_livecd.sh program library is copied. Next, the boot option and its function of the /isolinux/isolinux.cfg file in the system image file is created and edited. Finally, the subprogram MKINITRAM is run to copy the vmlinuz file and make the initrd file.

The subprogram MKINITRAM performs the following steps to copy the vmlinuz file and make the initrd file. Firstly, the /isolinux/isolinux.cfg file of the system image file is edited to add the label and content of the kernel version to be processed. Then, the vmlinuz file of the kernel version to be processed is copied to the /isolinux directory of the system image file and is renamed as vmlinuz+N where N is the sequence of processing. For example, the first processed vmlinuz file is renamed as vmlinuz0, the second processed vmlinuz file is renamed as vmlinuz1, and the subsequent files are renamed in the same fashion. Next, a subprogram mayflower-RHEL (will be described later) is run. If an ordinary kernel is to be processed, “cat /proc/cmdline” string is designated to the subprogram mayflower-RHEL; if Xen is to be processed, “echo $CMDLINE” string is designated to the subprogram mayflower-RHEL. The subprogram mayflower-RHEL makes an initrd file which corresponds to the vmlinuz+N file and is named as initrd+N according to the kernel version to be processed and corresponding string. For example, an initrd file which is named as initrd0 is generated corresponding to vmlinuz0, an initrd file which is named as initrd1 is generated corresponding to vmlinuz1, and other initrd files are generated in the same fashion. Finally, if there is an unprocessed kernel (i.e., an operating system has not been processed), the MKINITRAM proceeds to process a next kernel according to its workflow. Whether there is an unprocessed kernel is adjudged from the check result.

FIG. 3 is a flow chart of a method for making the initrd file according to one embodiment of the present invention. Referring to FIG. 3, in the illustrated embodiment, the initrd file is made by the subprogram mayflower-RHEL performing the following steps. Firstly, the variable is set and asserted (step S301). If the kernel to be processed is the Xen kernel, the variable is asserted by: CMDLINE=“root=CDLABEL=RHEL5_{—}1_i386 rootfstype=iso9660 ro quiet liveimg rhgb”; if the kernel to be processed is not the Xen kernel, the assertion is not made. Then, step S302 is performed which makes a file structure for the initrd file. Step S303 is performed which sets the driver programs to be added. In the illustrated embodiment, the driver programs of storage device interfaces (including ide, sata, scsi, sas, usb) and customized storage devices are added into a list. Next, in step S304, /etc/fstab directory for the initrd file is made. In step S305, all binary commands that will be used and program library that is to be used by these binary commands are copied to the /etc/fstab directory. In step S306, an interface script which is named as run-init is created in sbin/ directory to establish an interactive command environment for a RedHat Nash command interpreter. In step S307, an initial script which is named as init is created. The init is the first file to be executed as the operating system is booted. In step S308, the driver programs, binary commands, program library, interface script, and initial script are packaged, and then are compressed a first time using a program cpio and compressed a second time using a program gunzip. The compress command is as follows: find. |cpio --quiet -o -H newc|gzip -9>../initramfs. After this command is executed, a compressed file which is named as initramfs is created. This compress file is copied to the /isolinux directory of the disc image file and is renamed as initrd+N where N corresponds to the vmlinuz+N. The file named as initrd+N is the initrd file. After the initrd file is made, the driver programs, binary commands, program library, interface script and initial script are deleted.

The following is the content of a boot file (isolinus,cfg) according to one embodiment of the present invention.

```
default vesamenu.c32
timeout 100
menu background splash.jpg
menu title Welcome to RHEL5.1 i386 LiveCD
menu color border 0 #ffffffff #00000000
menu color sel 7 #ffffffff #ff000000
menu color title 0 #ffffffff #00000000
menu color tabmsg 0 #ffffffff #00000000
menu color unsel 0 #ffffffff #00000000
menu color hotsel 0 #ff000000 #ffffffff
menu color hotkey 7 #ffffffff #ff000000
menu color timeout_msg 0 #ffffffff #00000000
menu color timeout 0 #ffffffff #00000000
menu color cmdline 0 #ffffffff #00000000
menu hidden
menu hiddenrow 5
label linux0
  menu label Boot RHEL5.1 i386 2.6.18-53.el5
  kernel vmlinuz0
  append initrd=initrd0.img root=CDLABEL=RHEL5_1
              _i386 rootfstype=iso9660 ro quiet liveimg rhgb
menu default
label check0
  menu label Verify and boot RHEL5.1 i386 2.6.18-53.el5
  kernel vmlinuz0
  append initrd=initrd0.img root=CDLABEL=RHEL5_1
              _i386 rootfstype=iso9660 ro quiet liveimg rhgb
              check
label linux1
  menu label Boot RHEL5.1 i386 2.6.18-53.el5PAE
  kernel vmlinuz1
  append initrd=initrd1.img root=CDLABEL=RHEL5_1
              _i386 rootfstype=iso9660 ro quiet liveimg rhgb
label check1
  menu label Verify and boot RHEL5.1 i386 2.6.18-53.el5PAE
  kernel vmlinuz1
  append initrd=initrd1.img root=CDLABEL=RHEL5_1
              _i386 rootfstype=iso9660 ro quiet liveimg rhgb
              check
label linux2
  menu label Boot RHEL5.1 i386 2.6.18-53.el5Xen
  kernel mboot.c32
  append Xen2.gz --- vmlinuz2 --- initrd2.img
              root=CDLABEL=RHEL5_1_i386 rootfstype=
              iso9660 ro quiet liveimg rhgb
label check2
  menu label Verify and boot RHEL5.1 i386 2.6.18-53.el5Xen
  kernel mboot.c32
  append Xen2.gz --- vmlinuz2 --- initrd2.img
          root=CDLABEL=RHEL5_1_i386 rootfstype=
              iso9660 ro quiet liveimg rhgb check
label local
  menu label Boot from local drive
  localboot 0xffff
```

The above content is described in the following in sequence. Default vesamenu.c32 means designating vesamenu.c32 as a default boot window kernel and vesamenu.c32 supports the background of a jpg image type. Timeout 100 means setting default waiting time as 100×0.1 seconds, i.e., 10 seconds. If not selected before the time limit expires, the system is booted with the below kernel with a default label. Those commands started with menu are to set background, title, line color and function of the hotkeys of the option.

Label linux0 is the first kernel label. The command started with menu means to display “Boot RHEL5.1 i386 2.6.18-53.e15”. This kernel label uses an ordinary kernel grammar, and the boot kernel is set as vmlinuz0 virtual memory file. The initrd file is set as initrd0.img. root indicates a location of the root device of the operating system. CDLABEL=RHEL5_{—}1_i386 means that the root device is located on a device which CD label (CDLABEL) is named as RHEL5_{—}1_i386. rootfstype=iso9660 means that the file type (fstype) of the root device is of an iso9660 format. Ro, quiet, liveimg and rhgb are all boot options, wherein the kernel cannot recognize the quiet and liveimg commands and needs the init script of the initrd file to instruct how to process these commands. Menu default means that the kernel label is the default label for the boot menu.

In addition, label linux2 shows a method of using the Xen kernel. Firstly, the boot kernel is directed to mboot.c32 to load a plurality of system boot files, and Xen2.gz, vmlinuz2, initrd2.1 mg are added one by one. In the Xen kernel, the boot option can not be copied to /proc/cmdline directory and, therefore, are instead processed by setting the variables.

For other labels, label local is to associate a boot device to a boot loader in a first disk device that is recorded in BIOS to boot. Label check0 and label check2 are the same as above labels except the keyword “check”. Label linux1 is to replace the kernel file with vmlinuz1 and initrd1.img.

In summary, the method for making the test fixture of the embodiment is to move the Linux operating system on the machine to the test fixture. After the Linux operating system is installed, an initrd file and a vmlinuz are made according to a boot file that is made according to the Linux operating system and real environment of the machine, such that the test fixture is bootable with multiple kernels and shares the same services and settings (e.g., network service, mail service, database settings that have been set in the machine) as in the customized operating system in the storage device. In addition, installation of an operating system is not required to use the test fixture, such that the computer can be booted with multiple kernels and perform rapid test. Furthermore, when the test fixture operates, it provides an operating environment as if the customized Linux operating system were running. Therefore, the time for testing the computer products is reduced, and multi-kernel test can be carried out, thereby increasing the shipment speed and quality of the computer products.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for making a test fixture, suitable for making a test optical disc to be used as a test fixture for testing a computer product, comprising:
installing an Open Source operating system to a storage device of a computer;
installing at least one test program for the testing to the storage device;
checking which kernels have been installed in the Open Source operating system to obtain a check result;
copying a part of or entire content of the storage device to a system image file except a boot file;
making a boot file directory structure in the system image file;
customizing the boot file of the Open Source operating system in the storage device to make a disc boot file in the boot file directory structure;
recording the check result in the disc boot file;
making an initial Ram disk file corresponding to the check result in the boot file directory structure according to the boot file in the storage device; and
making a bootable test disc using the system image file.

2. The method for making the test fixture according to claim 1, further comprising installing at least one driver program required by the computer to the storage device.

3. The method for making the test fixture according to claim 1, further comprising creating at least one file folder for network test to the storage device.

4. The method for making the test fixture according to claim 1, further comprising:
setting a halt condition; and
halting the method for making the test fixture if an event in accordance with the halt condition occurs.

5. The method for making the test fixture according to claim 1, further comprising:
checking the operating system of the computer; and
ending the method for making the test fixture if the operating system of the computer does not satisfy the needs for carrying out the making method.

6. The method for making the test fixture according to claim 1, further comprising an optimization operation performed to remove unnecessary function from the Open Source operating system.

7. The method for making the test fixture according to claim 1, further comprising creating an empty system image file as the system image file.

8. The method for making the test fixture according to claim 1, further comprising compressing the system image file.

9. The method for making the test fixture according to claim 6, wherein the system image file is compressed by using a Squashfs compress technology.

10. The method for making the test fixture according to claim 1, wherein making the disc boot file comprises:
making and editing a boot menu and its function; and
making a kernel label and its content.

11. The method for making the test fixture according to claim 1, wherein making the initial Ram disk file comprises:
setting and asserting a corresponding variable according to the kernel to be processed;
making a file structure for the initial Ram disk file
setting driver programs to be added, and adding driver programs of a communication interface and customized storage device to a list;
creating a directory for the initial Ram disk file in the boot file directory structure;
copying the all binary commands to be used by the kernels and its program library to the directory;
making an initial script; and
compressing the file after the driver program, binary command, program library and initial script are packaged, the compressed file being the initial Ram disk file.

12. The method for making the test fixture according to claim 1, wherein the bootable test disc is carried out in accordance with ISO9660 standard.
